(19) United States
(12) Patent Application Publication
(10) Pub. No.: US 2006/0062478 A1
(43) Pub. Date: Mar. 23, 2006

(54) Region-sensitive compression of digital video

(75) Inventors: Ahmet Enis Cetin, Ankara (TR); Mark Kenneth Davey, Bromley (GB); Halil I. Cuce, Ankara (TR); Andrea Elvis Castellari, Horley (GB); Adem Mulayim, Ankara (TR)

Correspondence Address: GROOVER & HOLMES, BOX 802889, DALLAS, TX, 75380-2889, US

(73) Assignee: Grandeye, Ltd.,

(21) Appl. No.: 11/203,807

(22) Filed: Aug. 15, 2005

Related U.S. Application Data
(60) Provisional application No. 60/601,813, filed on Aug. 16, 2004.
(60) Provisional application No. 60/652,885, filed on Feb. 15, 2005.

(51) Int. Cl. G06K 9/36

(52) U.S. Cl. 382/232

(57) ABSTRACT

A video coding method for surveillance videos allowing some regions of the scene to be encoded in an almost lossless manner. Such Regions of Interest (RoI) can be determined a priori or they can be automatically determined in real-time by an intelligent system. The user can set high priority in such regions a priori or the intelligent video analysis algorithm can automatically assign some windows a higher priority compared to the rest of the video. In a preferred embodiment, this can be achieved by canceling the motion estimation and compensation operations, and then decreasing the size of the quantization levels during the encoding process in the RoI. The present inventions can produce MPEG compatible bit-streams without sending any side information specifying the RoI.

### CROSS REFERENCE TO RELATED APPLICATIONS

This application claims priority both from U.S. provisional patent application 60/601,813 filed on Aug. 16, 2004 (atty. docket GRND-06P), and also from U.S. provisional patent application 60/652,885 filed on Feb. 15, 2005 (atty. docket. GRND-06P2), both of which are hereby incorporated by reference.

### BACKGROUND AND SUMMARY OF THE INVENTION

The present application relates to systems and methods for encoding and decoding video signals, and more specifically to systems and methods for selective compression of video streams.

One of the basic challenges in digital video is the substantial bit rate implied by a raw video stream. For example, an effective screen resolution of 640*480 at a frame rate of 30 Hz and 24 bits per pixel would imply a raw uncompressed bit rate of 220 million bits per second. For this reason digital video encoding normally uses compression algorithms of some sort. Since the human brain performs image recognition using only a small fraction of this bandwidth, and since there is a high correlation between successive frames of a video stream, large compression ratios can be achieved.

Video surveillance systems and cameras are widely used in many practical applications. A typical video signal produced by a surveillance camera consists of both foreground objects containing important information and the background, which may contain very little useful information. Conservation of transmission and storage bandwidth is often particularly desirable in surveillance systems.

Current digital video recording systems use wavelet data compression or DCT-based MPEG (Moving Pictures Expert Group) video compression standards to compress wide-angle video, which are developed for coding ordinary video. (DCT is the Discrete Cosine Transform, but of course other data transformations and compression algorithms can be used in alternative embodiments.)

U.S. application Ser. No. 10/837,325 (Attorney Docket No. GRND-14), filed Apr. 30, 2004 entitled “Multiple View Processing in Wide-Angle Video Camera,” by Yavuz Ahiska, which is hereby incorporated by reference, is an example of a camera system producing wide-angle video. Such camera systems are widely used in surveillance systems. Ordinary video encoding methods cannot effectively compress the video produced by such a camera system because a typical wide-angle video contains not only regions of interest (RoI), but also large regions corresponding to sky, walls, floor etc carrying very little information.

Image and video compression is widely used in Internet, CCTV, and DVD systems to reduce the amount of data for transmission or storage. With the advances in computer technology it is possible to compress digital video in real-time. Recent image and video coding standards include JPEG (Joint Photographic Experts Group) standard, JPEG 2000 (ISO/IEC International Standard, 15444-1, 2000, which is hereby incorporated by reference), MPEG family of video coding standards (MPEG-1, MPEG-2, MPEG-4) etc. The above standards, except JPEG 2000, are based on discrete cosine transform (DCT) and on Huffman or arithmetic encoding of the quantized DCT coefficients. They compress the video data by roughly quantizing the high-frequency portions of the image and sub-sampling the color difference (chrominance) signals. After compression and decompression, the high frequency content of the image is generally reduced. The human visual system (HVS) is not very sensitive to modifications in color difference signals and details in texture, which contribute to high-frequency content of the image. In MPEG-1 and MPEG-2 standards the concept of RoI is not defined. These video coding methods do not give any emphasis to certain parts of the image, which may be more interesting compared to the rest of the image. Only the MPEG-4 standard has the capability of handling RoI. But even then, the boundary of each RoI has to be specified as side information in the encoded video bit-stream. This leads to a complex and expensive video coding system. Even in simple shape boundaries such as rectangles and circles, the receiver has to produce a 1 bit/pixel RoI mask. The size of the RoI mask can be as large as the entire image size. This may be a significant overhead in the compressed wide-angle video, which may contain large RoIs. A separate algorithm for ROI mask compression may be needed and this leads to more complex video encoding systems.

The recent JPEG 2000 standard which is based on wavelet transform and bit-plane encoding of the quantized wavelet coefficients provides extraction of multiple resolutions of an encoded image from a given JPEG 2000 compatible bit-stream. It also provides RoI encoding, which is an important feature of JPEG 2000. This lets the allocation of more bits in a RoI than the rest of the image while coding it. In this way, essential information of an image, e.g. humans and moving objects, can be stored in a more precise manner than sky and clouds etc. But JPEG 2000 is basically an image-coding standard. It is not a video coding standard and it cannot take advantage of the temporal redundancy in video. In non-RoI portions of surveillance video there is very little motion in general. Therefore, pixels in a non-RoI portion of an image frame at time instant n is highly correlated with the corresponding pixels at image frame at time instant n+1.

Motion JPEG and Motion JPEG 2000 are video-coding versions of the JPEG and JPEG 2000 image compression standards, respectively. In these methods, a plurality of image frames forming the video is encoded as independent images. They are called intra-frame encoders because the correlation between consecutive image frames is not exploited. Compression capability of Motion JPEG and Motion JPEG 2000 are not as high as the MPEG family of compression standards, in which some of the image frames are compressed inter-frame, i.e., they are encoded by taking advantage of the correlation between the image frames of the video. In addition, a boundary-shape encoder is required at the encoder side and a shape-decoder at the receiver with boundary information being transmitted to the receiver as side information. The decoder has to produce the RoI mask defining the coefficients needed for the reconstruction of the RoI (see Charilaos Christopoulos (editor), ISO/IEC JTC1/SC29/WG1 N988 JPEG 2000 Verification Model Version 2.0/2.1, Oct. 5, 1998, which is hereby incorporated by reference). Obviously, this increases the computational complexity and memory requirements of the receiver. It is desirable to have a decoder as simple as possible.

U.S. Pat. No. 6,757,434 by Miled and Chebil entitled “Region-of-interest tracking method and device for wavelet-based video coding,” which is hereby incorporated by reference, describes an RoI tracking device for wavelet based video coding. It does not appear that this system can be used in DCT based video compression systems. Also, this system provides the RoI information to the receiver as side information.

Another problem with ordinary video encoders is that when there is a buffer overflow or transmission channel congestion problem, they uniformly increase the quantization levels over the entire image to reduce the amount of transmitted bits. This may produce degradation or even the loss of very important information in RoIs in surveillance videos.

In U.S. Pat. No. 6,763,068, entitled “Method and apparatus for selecting macro-block quantization parameters in a video encoder,” dated Jul. 13, 2004 and Published U.S. patent application No. 20030128756, entitled “Method and apparatus for selecting macro-block quantization parameters in a video encoder,” dated Jul. 10, 2003, which are both hereby incorporated by reference, L. Oktem describes a system for adjusting the quantization parameters in an adaptive manner in RoIs. In RoIs, the quantization parameter is reduced to accurately represent the RoI. The system is not designed for surveillance videos.

### METHOD FOR REGION SENSITIVE COMPRESSION OF DIGITAL VIDEO

The present application discloses new approaches to encoding video signals, and new surveillance systems which provide more efficient encoding.

In one class of embodiments, video coding methods and systems for surveillance videos are presented. A preferred embodiment takes advantage of the nature of the wide-angle video by judiciously allocating more bits to important regions of a scene as compared to regions containing little information e.g., blue sky, clouds, floor or room etc. The present inventions can encode some regions of the scene in an almost lossless manner. In a preferred embodiment of this class of inventions, these regions can be determined a priori or they can be automatically determined in real-time by an intelligent system determining the existence of motion and humans. It is important to represent biometric properties of humans as accurately as possible during data compression. In a preferred embodiment, the user can set high priority in such regions a priori or the intelligent video analysis algorithm can automatically assign some windows of the video higher priority compared to the rest of the video. In a typical differential video-coding scheme, including MPEG family of video compression standards, there are Intra-frame compressed frames (I-type), Predicted (P-type), and Bi-directionally predicted (B-type) frames. P-type and B-type frames are estimated from I-type frames. During the prediction process, errors may be introduced to the encoded video. In a preferred embodiment, the prediction process is cancelled to eliminate possible errors in RoIs. Other video coding methods do not nullify the motion estimation or compensation operation in RoIs, they only decrease the size of the quantization levels during the encoding process.

A preferred embodiment of the present inventions has the capacity to produce MPEG compatible bit-streams. It not only provides MPEG-1 and MPEG-2 compatible bit-streams, but also MPEG-4 compatible bit-streams, which can be decoded by all MPEG-4 decoders. A preferred embodiment of the present inventions can also be used in both DCT and wavelet-based video coding systems.

The present inventions do not require any side information to encode RoIs. A preferred embodiment of the present inventions can have a differential encoding scheme at non-RoI portions of the video, which can drastically reduce the number of bits assigned to regions that may contain very little semantic information.

An example embodiment of the present inventions first increases the quantization levels in non-RoI regions of the video when there is a buffer overflow. If the channel congestion gets worse then, it can throw away the AC coefficients of the non-RoI blocks and can represent them using only their DC coefficients. If this bit rate reduction is not enough then it can increase the quantization levels of the RoI blocks as a last choice. In other words, essential information in RoIs of the image can be kept as accurate as possible in the case of a buffer overflow or channel congestion. The approach described above is an intra-frame method giving more emphasis to RoIs.

Another preferred embodiment of the present inventions varies the compression rate according to the content of the video and a RoI detection algorithm analyzes the image content and can allocate more bits to regions containing useful information by increasing the quantization parameters and canceling the inter-frame coding in RoIs. It may be possible to allocate more bits to certain parts of the image compared to others by changing the quantization rules.

A standard video encoding system cannot give automatic emphasis to regions of interest and cannot assign more bits per area to RoI's compared to non-RoI regions of the wide-angle video.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 shows a typical security monitoring application, where a camera is monitoring a large room containing some regions of interest.

FIG. 2 shows another common security monitoring application, where the regions of interest are defined to capture human face images as accurately as possible when people enter the room.

FIGS. 3, 4 and 5 are flow diagrams of video-encoding based on MPEG-1, MPEG-2 and MPEG-4 video encoders, respectively.

FIG. 6 is a flow diagram of video encoding scheme using a wavelet transform.

FIG. 7 shows compression of a block of pixels, b_{n+1,m} in the RoI during the inter-frame data compression mode of a differential video encoder.

FIG. 8 shows decompression of a block of pixels, b_{n+1,m} in the RoI during the inter-frame data compression mode of a differential video encoder which does not support the cancellation of inter-frame coding.

FIG. 9 shows one example system consistent with implementing a preferred embodiment of the present innovations.

FIG. 10 shows another example context consistent with implementing preferred embodiments of the present innovations.

FIG. 11 shows another example system consistent with implementing preferred embodiments of the present innovations.

### DETAILED DESCRIPTION

The numerous innovative teachings of the present application will be described with particular reference to the presently preferred embodiment (by way of example, and not of limitation).

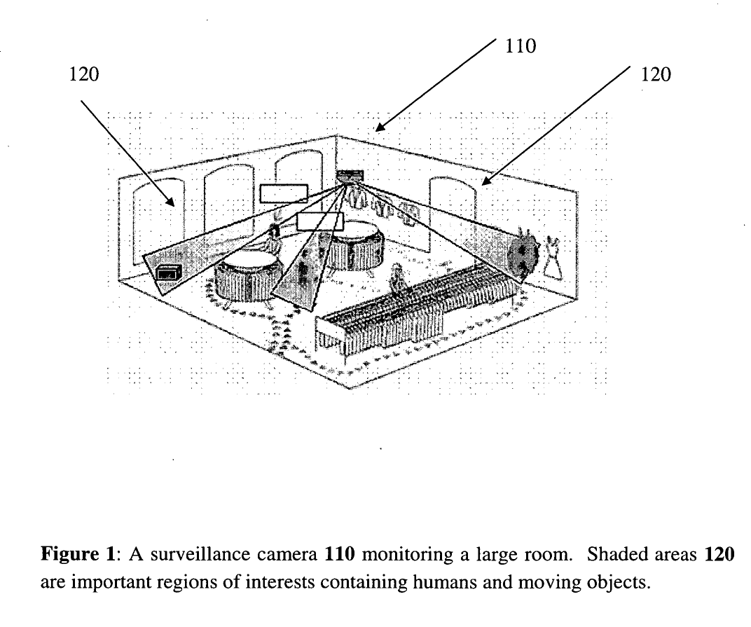

Video surveillance systems and cameras are widely used in many practical applications. A typical video signal produced by a surveillance camera consists of both foreground objects containing important information and the background, which may contain very little useful information. Current digital video recording systems use vector quantization, wavelet data compression, or Discrete Cosine Transform (DCT) based MPEG video compression standards to encode surveillance videos, which are developed for coding ordinary video. In FIG. 1 a wide-angle camera 110 monitoring a large room is shown. Shaded areas 120 are important regions of interests containing humans and moving objects. In some embodiments such RoIs can be automatically defined by a motion-detection or object-tracking algorithms.

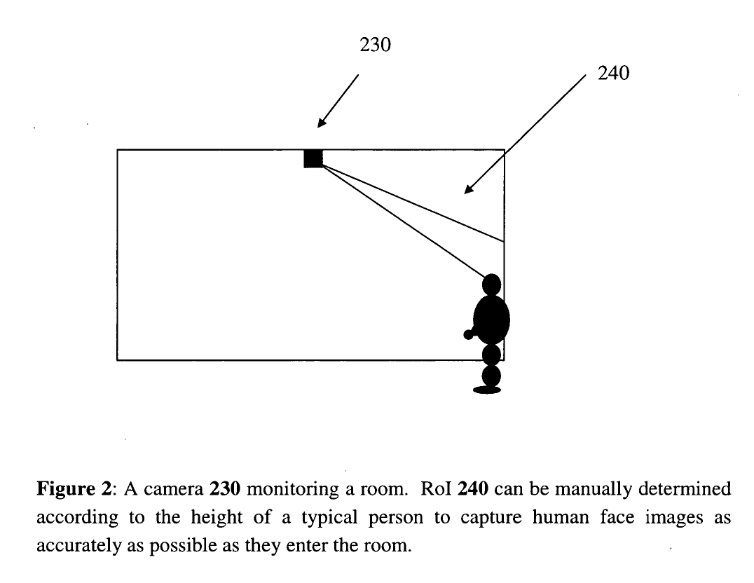

In FIG. 2, another camera 230 monitoring a room is shown. RoI 240 can be manually determined according to the height of a typical person to capture human face images as accurately as possible as they enter the room. The key idea is to assign more bits per area to RoIs compared to non-RoIs to achieve a semantically meaningful representation of the surveillance video. The main goal of the present invention is judiciously allocate more bits per area to regions of wide-angle video containing useful information compared to the non-RoI regions.

Review of Differential Video Coding Methods: A raw digital video consists of plurality of digital image frames, and there is high correlation between the consecutive image frames in a video signal. In a typical differential video-coding scheme, including MPEG family of video compression standards, there are Intra-frame compressed frames (I-type), and Predicted (P-type) frames and Bi-directionally predicted frames (B-type), which are estimated from I-type image frames. MPEG encoders transmit encoded I-type frames, and prediction vectors and encoded difference images for P-type, and B-type frames.

In a typical video consecutive image frames are highly related with each other. For example, if there is no moving object in the scene and the camera is fixed then the image frame In at time instant n should be the same as the next frame of the video Iₙ₊₁ in the absence of camera noise. Based on this fact, it is advantageous to differentially encode the image sequence. Let the difference image Dₙ₊₁ be defined as follows
Dₙ₊₁=Iₙ₊₁−Iₙ
In many video encoding schemes the current image Iₙ and the difference image Dₙ₊₁ are compressed instead of Iₙ and Iₙ₊₁ pair of images. Since the dynamic range of a typical pixel in Dₙ₊₁ is much smaller than the dynamic range of pixels in Iₙ and Iₙ₊₁. Thus it is better to encode Dₙ₊₁ instead of Iₙ₊₁. It is said that Iₙ is compressed intraframe only (I-type frame) and Iₙ₊₁ is compressed in a predictive manner (P-type frame).

If there is a moving object in the scene or camera moves at time instant n then straightforward differencing may not produce good results around the moving object. In this case, the difference image is defined as follows
Dₙ₊₁=Iₙ₊₁−G(Iₙ)
where G(.) is a time-varying function compensating the camera movement, and moving regions. The decoder reconstructs the image Iₙ₊₁ from Dₙ₊₁ and Iₙ according to the the function G(.). In a block-based video coding scheme, including MPEG family of compression schemes, image frames are divided into small non-overlapping square blocks of pixels. Usually, the block size is 8 by 8 and the differencing operation is carried out block by block. Let the current block be b_{n,m} and the corresponding block in image Iₙ₊₁ be b_{n+1,m}. If both b_{n,m} and b_{n+1,m} are part of the background of the scene then the corresponding difference block in the image Dₙ₊₁ is equal to
d_{n+1,m}=b_{n+1,m}−b_{n,m}
which contains zero valued pixels or pixels with values close to zero due to noise. If the block b_{n+1,m} is part of a moving object and the block b_{n,m} is part of the background (or vice versa) then differencing these two blocks will be meaningless. However, b_{n+1,m} can be predicted from the corresponding block b_{n,p} on the moving object. In this case the difference block is defined as
d_{n+1,m}=b_{n+1,m}−b_{n,p}
The vector v_{n,m} from the center (or upper-left corner) of the block b_{n,p} to the center (or upper-left corner) of b_{n,m} is defined as the motion vector of the m-th block. Motion vectors uniquely define the motion compensation function G(.) defined above. The video encoder has to transmit the motion vectors in addition to the difference blocks to the decoder to achieve reconstruction.

Estimation of block motion vectors can be carried out using the current and the previous image frames of the video as well. In fact, in MPEG based video coding algorithms the motion vector of a given 8 by 8 image block in the current frame is computed with respect to the previous frame. A block similar to the given block of the current image frame is searched in the previous frame. Various similarity measures including Euclidian distance and mean absolute difference are used for comparing blocks of the current frame with the blocks of the previous video image frame. Once such a block is found then the motion vector is computed as described above.

In a real-time video encoding system the motion vector estimation may not be very accurate. Motion vector estimation in the face image of a person may produce severe artifacts and this may lead to errors in manual or automatic human identification and recognition process, which can be carried out in real-time or off-line. Therefore, in Regions of Interest (RoI) it is wiser to cancel the motion estimation-compensation process in an automatic manner and simply compress the original image pixels. In other words, an image data block in a region of interest is represented as,
d_{n+1,m}=b_{n+1,m}
Intra-frame coding is allowed in macro-block level in MPEG type algorithms. A macro-block consists of four 8×8 blocks or 16×16 pixels in the luminance image frame and the corresponding chrominance image blocks. In 4:1:1 sub-sampling format 8×8 pixels in U and V domain correspond to said 16×16 luminance pixels. Therefore, in MPEG family of algorithms inter-frame coding is simply cancelled in our invention in macro-blocks forming the RoI. If the video coding method does not allow macro-block level modifications then the following strategy can be implemented: An image data block in an RoI can be also represented as
d_{n+1,m}=b_{n+1,m}−b_{n,c}
where b_{n,c} represents a block whose pixel values are equal to a constant. The AC coefficients of the DCT of b_{n+1,m} and b_{n+1,m}−b_{n,c} are the same because the DCT is a Fast Fourier Transform-like transform. The motion estimation process is effectively cancelled in an RoI by performing the DCT of all the blocks b_{n+1,m} in the RoI or equivalently by performing the DCT of b_{n+1,m}−b_{n,c}. We call this video coding strategy effective intra-frame compression because of the fact that blocks are basically intra-frame compressed in spite of differencing of two blocks one from the n-th frame and the other from the n+1'st frame of the video.

This invention identifies an image block with almost constant values outside the region of interest. Such blocks exist in portions of the image containing the sky or walls of a room in indoor scenes etc. A block with almost constant pixel values can be represented using its DC value only representing the average pixel value of the block. No AC coefficient is used to encode this block. An encoder consistent with the present innovations defines the motion vector of a block in the region of interest with respect to said block, which is encoded using only its DC value. The motion vector v_{n,m} of the block b_{n,m} is defined as the vector from the center (or upper-left corner) b_{n,m} to the center (or upper-left corner) b_{n,c} representing a block whose values are only DC encoded. In other words, motion estimation or motion compensation process is not implemented in the RoI. A motion vector whose length and angle is determined with respect to a DC encoded block outside the RoI is simply assigned to each block in the RoI. In MPEG family of image coding standards there is no limit on the length of the motion vectors. Therefore, the motion vector can be accurately encoded without having any representation problem. Motion vectors of neighboring blocks are differentially encoded. This means that motion vectors of blocks in a RoI will be effectively encoded as they are very close to each other in length and angle.

MPEG-like differential video encoding schemes allow the use of several quantizers or they allow variable quantization steps during the representation of DCT domain data to overcome buffer or transmission channel overflow problems. Quantization levels can be changed at the macro-block level in MPEG-2 and MPEG-4. In this invention, we take advantage of this feature to finely quantize the AC coefficients of blocks in the RoI. This is also a second way of giving emphasis to the RoI because the image blocks in the RoI are more accurately encoded by finely quantizing them. This also means that more bits are assigned to an image block in the RoI compared to an ordinary image block, which is coarsely quantized in general. In most video encoding methods the quantized transform domain data is represented in binary form using either Huffman coding or arithmetic coding. The use of Huffman coding or arithmetic coding does not affect the embedded RoI representation method because RoI information is embedded into artificially defined motion vectors. In MPEG family of differential video coding methods motion vectors are separately encoded. Artificially defined motion vectors by the present inventions are not different from any other motion vector defined according to actual motion therefore they can be also represented in binary form using Huffman coding or arithmetic coding without effecting our RoI representation scheme.

An important feature of this approach is that no side information describing the RoI has to be transmitted to the receiver because the RoI information is embedded into the bit-stream via artificially defined motion vectors. The receiver does not have to change its operating mode from inter-frame decompression to intra-frame decompression to handle the RoI whose boundary information is embedded into the bit-stream by using motion vectors defined with respect to a DC encoded block outside the RoI. If an image frame is intra-frame compressed then the decoder performs inter-frame decompression but the decoder actually performs intra-frame operation in the RoI because a block in the RoI can be expressed as
b_{n+1,m}=d_{n+1,m}+b_{n,c}
where b_{n,c} represents a block whose pixel values are constant. Therefore, any MPEG decoder can also decode the bitstream generated by this invention. The concept of RoI is defined only in MPEG-4 standard. The MPEG-4 encoders which have the capability of RoI representation generate a bit stream containing not only the encoded video data information but also an associated side information describing the location and the boundary of RoI's in the video. The concept of RoI is not defined in MPEG-1 and MPEG-2 video compression standards. Therefore, this invention provides RoI capability to MPEG-1 and MPEG-2 video compression standards.

Some MPEG-4 decoder implementations always assume there is no RoI in the bit-stream and they cannot decode bit-streams containing RoI's. Even such simple MPEG-4 video decoders which cannot handle RoIs can decode bit-streams generated by the encoder of this invention which transmits or stores video without any side-information describing the RoI.

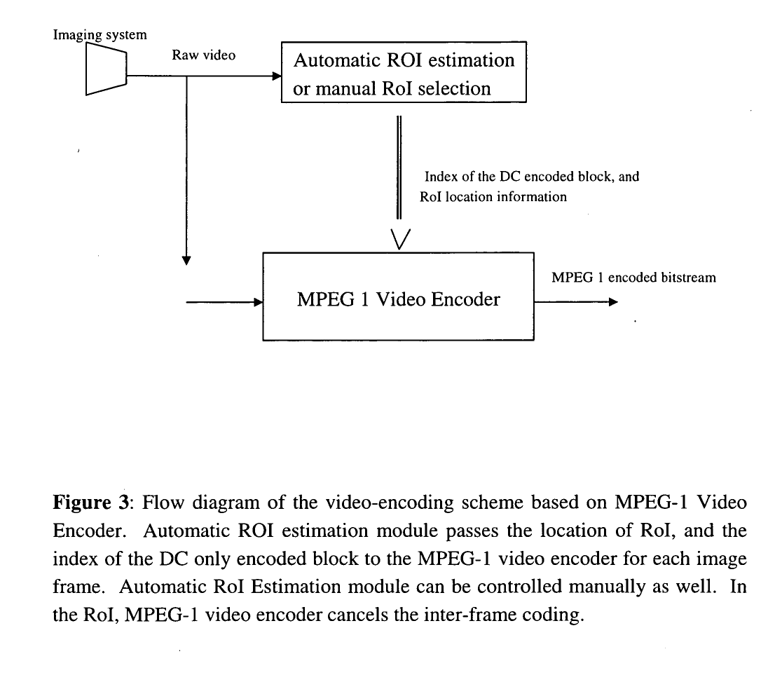

FIGS. 3, 4 and 5 are flow diagrams of video-encoding based on MPEG-1, MPEG-2 and MPEG-4 video encoders, respectively. Automatic ROI estimation module passes the location of RoI, and the index of the DC only encoded block to the video encoder for each image frame. Automatic RoI Estimation module can be controlled manually as well. In the RoI, video encoder nullifies the inter-frame coding. During intra-frame compression mode of the MPEG encoder only the quantization levels are reduced to accurately represent the RoI in the video bit-stream.

FIG. 3 is a flow diagram of the video-encoding scheme based on MPEG-1 Video Encoder. Automatic ROI estimation module passes the location of RoI, and the index of the DC only encoded block to the MPEG-1 video encoder for each image frame. (Alternatively, the Automatic RoI Estimation module can be controlled manually instead.) Within the RoI, the MPEG-1 video encoder nulls the inter-frame coding.

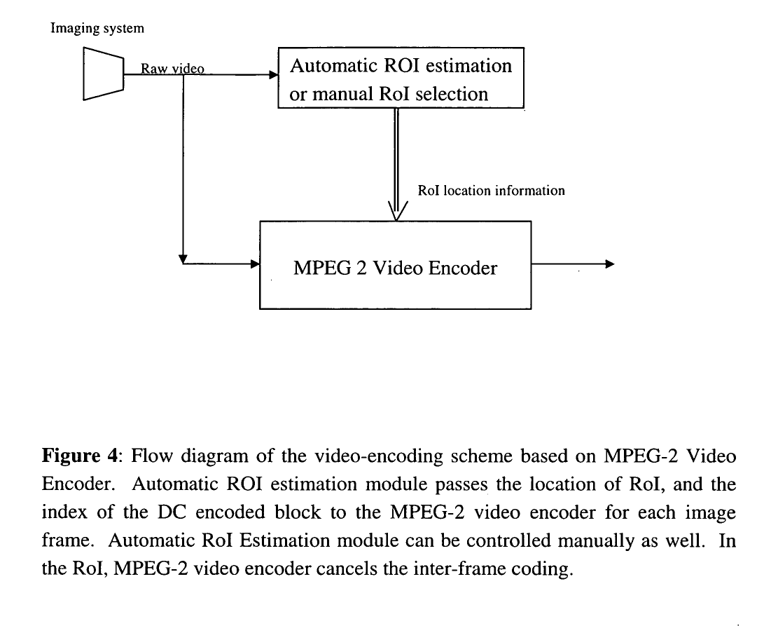

FIG. 4 is a flow diagram of the video-encoding scheme based on MPEG-2 Video Encoder. Automatic ROI estimation module passes the location of RoI, and the index of the DC encoded block to the MPEG-2 video encoder for each image frame. Automatic RoI Estimation module can be controlled manually as well. In the RoI, MPEG-2 video encoder nulls the inter-frame coding.

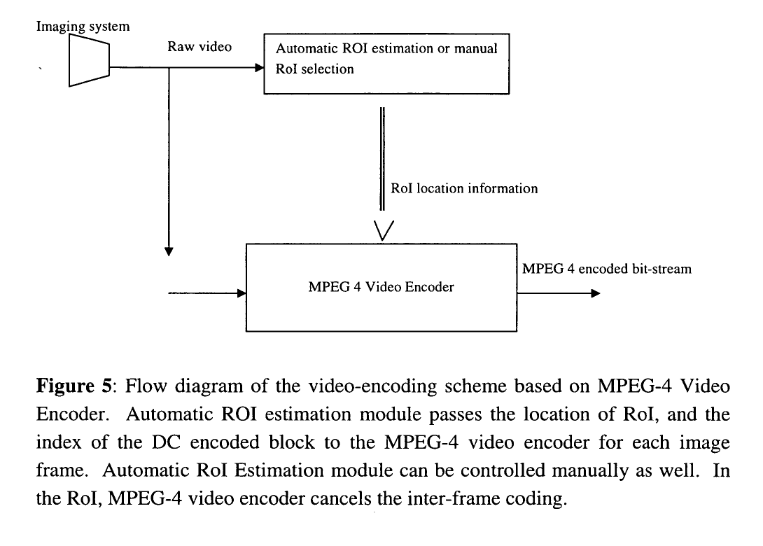

FIG. 5 is a flow diagram of the video-encoding scheme based on MPEG-4 Video Encoder. Automatic ROI estimation module passes the location of RoI, and the location of the DC encoded block to the MPEG-4 video encoder for each image frame. Automatic RoI Estimation module can be controlled manually as well. In the RoI, MPEG-4 video encoder nulls the inter-frame coding.

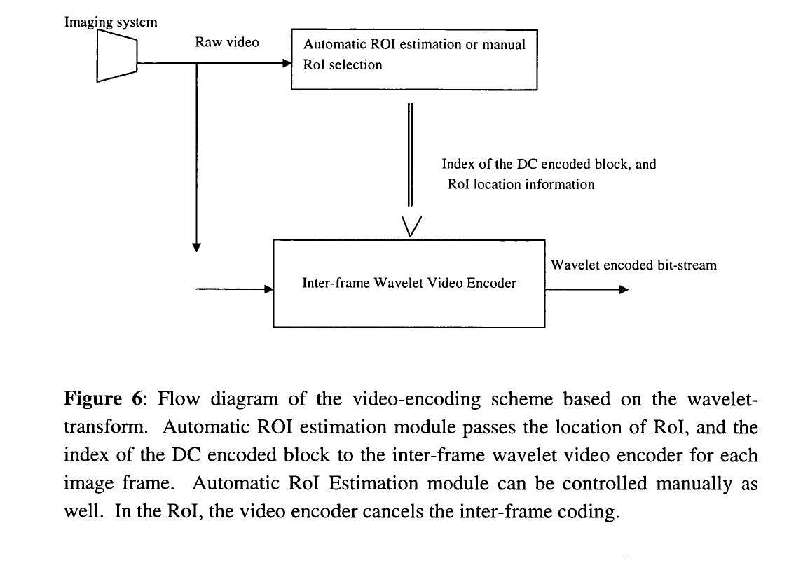

FIG. 6 is a flow diagram of the video-encoding scheme based on the wavelet transform. Automatic ROI estimation module passes the location of RoI, and the index of the DC encoded block to the inter-frame wavelet video encoder for each image frame. Automatic RoI Estimation module can be controlled manually as well. In the RoI, the video encoder nulls the inter-frame coding.

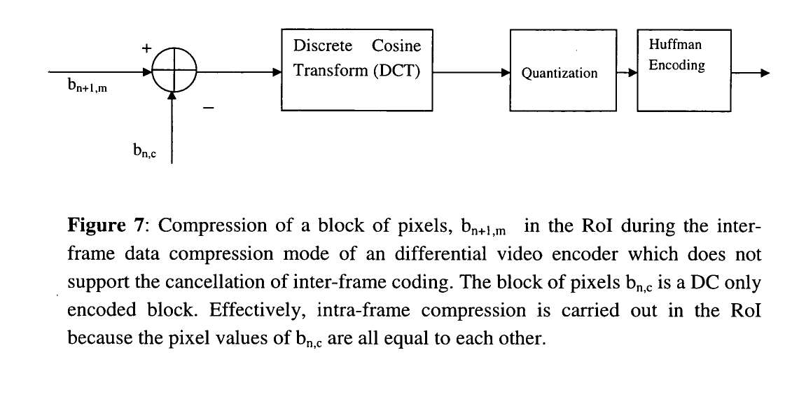

FIG. 7 shows compression of a block of pixels, b_{n+1,m} in the RoI during the inter-frame data compression mode of a differential video encoder which does not support the cancellation of inter-frame coding. The block of pixels b_{n,c} is a DC only encoded block. Effectively, intra-frame compression is carried out in the RoI because the pixel values of b_{n,c} are all equal to each other.

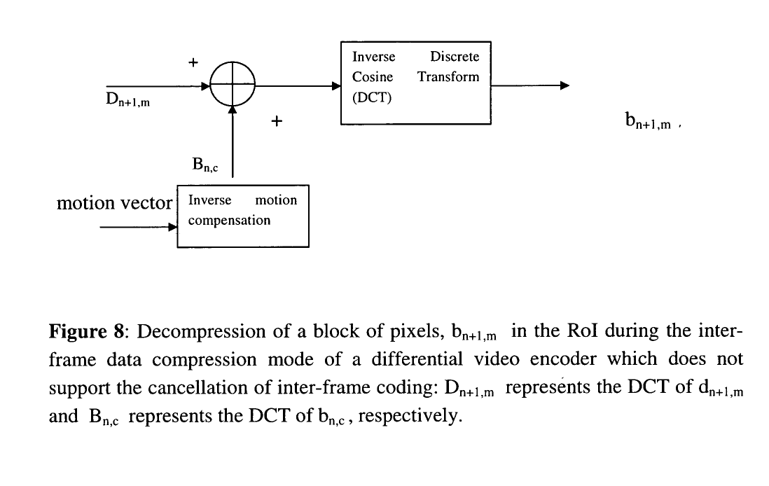

FIG. 8 shows decompression of a block of pixels, b_{n+1,m} in the RoI during the inter-frame data compression mode of a differential video encoder which does not support the cancellation of inter-frame coding: D_{n+1,m} represents the DCT of d_{n+1,m} and B_{n,c} represents the DCT of b_{n,c}, respectively.

The above RoI encoding scheme is described for image frames predicted in one direction, but extension to Bi-directionally predicted image frames (B-type frames) is straightforward. Anyone skilled in the art of image and video processing and compression can easily implement this extension.

In one class of example embodiments, the present innovations are implemented using a proprietary system including the Halocam™ (hereinafter the “Halocam”) and, in some embodiments, the Halocorder™ (hereinafter the “Halocorder”). In this example class of embodiments, the Halocorder is capable of recording and retrospective ePTZ for the Halocam. In various embodiments, the Halocorder provides full resolution recording of the 360×180 degree sensor output from the Halocam, and unrestricted retrospective ePTZ capability. As a distributed recording solution, it is capable of increasing the storage capability, allowing greater lengths of time to be stored before overwriting. Unrestricted retrospective ePTZ permits a recording to be played back using all the information of the original scene, making it possible to ePTZ as if viewing live images, without interfering with the constant recording of the scene (which continued during such playback). In various embodiments, the Halocorder and Halocam can be implemented as separate hardware devices in communication with one another (preferably but not necessarily co-located) or they can be integrated into a single hardware device.

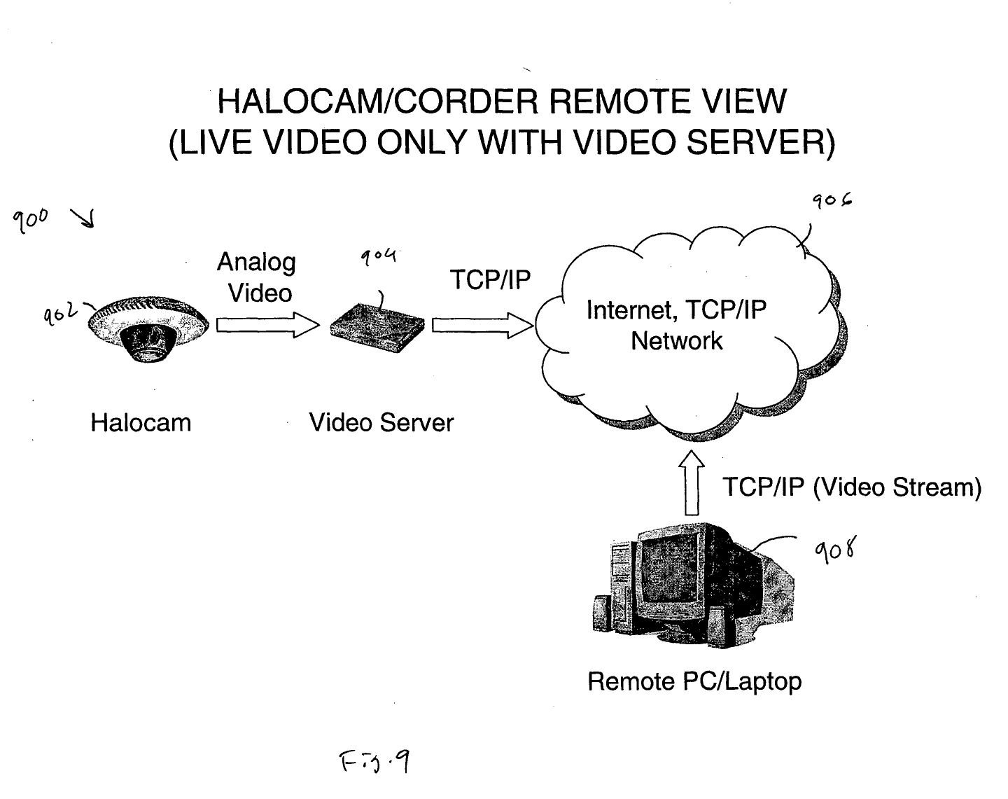

FIG. 9 shows one example system consistent with implementing a preferred embodiment of the present innovations. In this example, the system 900 includes Halocam 902 which preferably sends a recorded image or sequence of video frames as analog video to a video server 904. Remote computers can connect to the video server to view the Halocam video. For example, in this example embodiment, the video server is connected to a network 906, such as the Internet, TCP/IP network, an intranet, or other network. A remote computer 908 also connects to that network (directly or indirectly) to receive information from the video server to view the Halocam video. In this example, there is no communication between the remote PC 908 and the Halocam 902. In this example, the Halocorder is not shown. It can be integrated into this system separately, co-located or otherwise in communication with the Halocam, or it can be fully integrated into the Halocam device itself. In preferred embodiments, the functionality described in FIGS. 3-8 is implemented in the Halocorder, though other embodiments can implement such innovations in other ways, such as via the video server, the Halocam itself, or another remote computer.

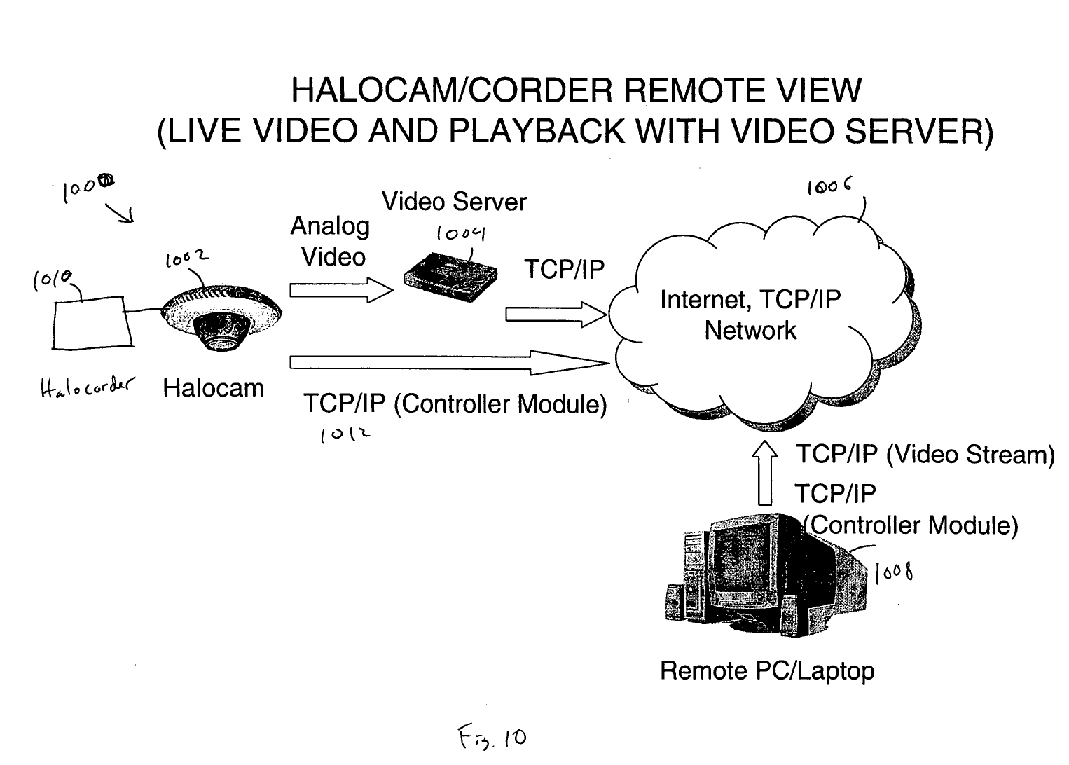

FIG. 10 shows another example context consistent with implementing preferred embodiments of the present innovations. In this example system 1000, Halocam 1002 communicates (preferably via analog video) with video server 1004 in a manner similar to that depicted in FIG. 9. Additionally, this example shows playback using a TCP/IP controller software application 1012 that connects to the Halocam and sends commands, such as “Switch to Playback,” “Start Playback,” “Pause,” “Switch to Live,” etc. This implementation allows live video and playback using TCP/IP that does not require the use of video server 1004, making communication directly from Remote PC 1008 with Halocam 1002 possible, preferably via network 1006. Controller module 1012 can be implemented in a variety of ways and/or locations, such as software located at the Halocam 1002 or Halocorder 1010 or remote PC 1008, or as hardware devices in those or other locations in communication with the system 1000. In other embodiments consistent with the present innovations, the Halocorder does not communicate with the external network. For example, the Halocam can be used for video playback, with the data coming from the imaging sensor being stored directly. After some processing, such as white-balancing and some filtering, for example, the image data is more suitable for human viewing.

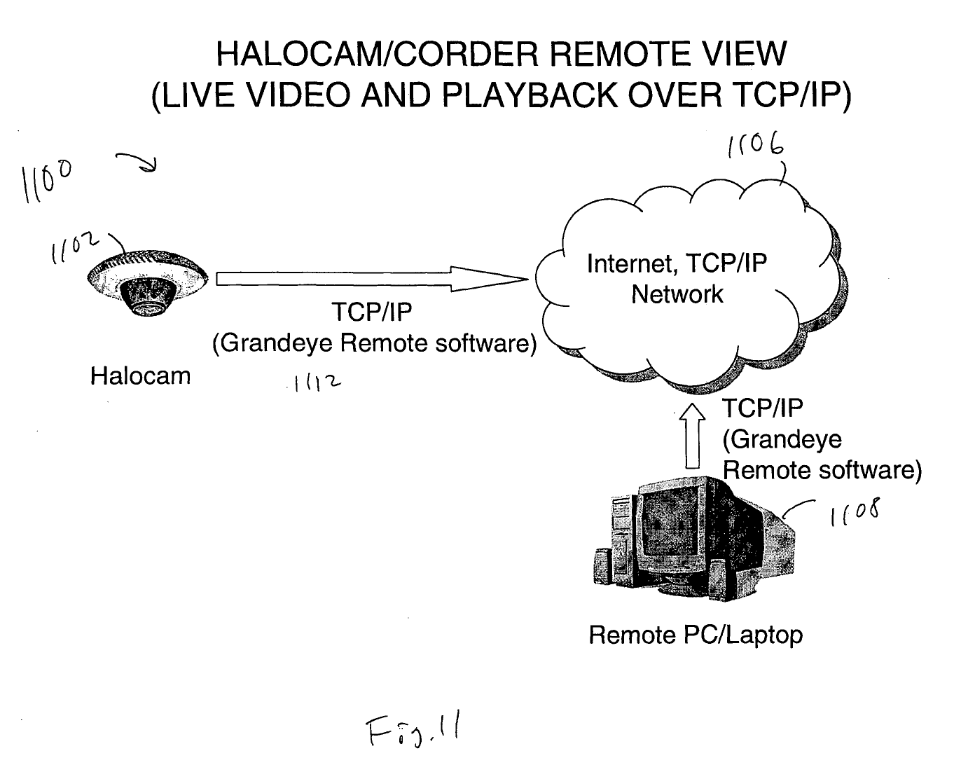

FIG. 11 shows another example system consistent with implementing preferred embodiments of the present innovations. In this example system 1100, Halocam 1102 communicates with network 1106 and sends compressed images directly to connected clients 1108 over the network 1106. In this example, there is preferably a communication module and/or software, such as remote software 1112 that is used to send live/playback images, decompression, debayering, unwrapping, and displaying compressed images. These functions can be distributed over one or more software or hardware modules.

The image data can be transformed into the transform domain using not only DCT but also other block transforms such as Haar, Hadamard or Fourier transforms can be also used. In wavelet based video coding methods the entire image or large portions of the image are transformed into another domain for quantization and binary encoding. Some wavelet based video coding methods also use block motion vectors to represent the motion information in the video. Our invention can provide an RoI representation for such differential wavelet video coding methods by artificially defining motion vectors in an RoI with respect to a constant valued image block outside the RoI or with respect to an non-RoI image block whose values are forced to take a constant value. In FIG. 6 the flow diagram of the video encoding scheme based on the wavelet transform is shown. Automatic ROI estimation module passes the location of RoI, and the index of the DC encoded block to the inter-frame wavelet video encoder for each image frame. Automatic RoI Estimation module can be controlled manually as well. In the RoI, the video encoder nullifies the inter-frame coding. During intra-frame compression mode of the wavelet video encoder only the quantization levels are reduced to accurately represent the RoI in the video bit stream.

Image pixels can be represented in any color representation format including the well-known Red, Green and Blue (RGB) color space and luminance (or gray scale) and chrominance (or color difference) color space (YUV). A DC only color encoding of an image block means that only the average value (or a scaled version of the average value) of each color channel is stored in the memory of the computer or transmitted to the receiver for this block.

Automatic RoI Estimation: The methods and systems have a built-in RoI estimation scheme based on detecting motion and humans in video. In FIG. 1, a camera 110 monitoring a large room is shown. Shaded areas 120 are important regions of interests containing humans and moving objects.

Motion and moving region estimation in video can be carried out in many ways. If the camera is fixed then any video background estimation based method can be used to determine moving regions. In surveillance systems including the method and the system described in the U.S. patent application Ser. No. 10/837,325 filed Apr. 30, 2004 (Attorney Docket No. GRND-14), which is hereby incorporated by reference, the camera is placed to a location which is suitable to screen a wide area. The method and the system first segments each image frame of the video into foreground and background regions using the RGB color channels of the video or using the YUV channels. Foreground-background separation in a video can be achieved in many ways (see e.g. GMM give reference here). The background of the scene is defined as the union of all stationary objects and the foreground consists of transitory objects. A simple approach for estimating the background image is to average all the past image frames of the video. The article “A System for Video Surveillance and Monitoring,” in Proc. American Nuclear Society (ANS) Eighth International Topical Meeting on Robotics and Remote Systems, Pittsburgh, Pa., Apr. 25-29, 1999 by Collins, Lipton and Kanade, which is hereby incorporated by reference, describes a recursive background estimation method in which the current background of the video is recursively estimated from past image frames using Infinite-duration Impulse Response (IIR) filters acting on each pixel of the video in a parallel manner. A statistical background estimation method is described in the article by C. Stauffer et al., “Adaptive background mixture models for real-time tracking,” IEEE Computer Vision and Pattern Recognition Conference, Fort Collins, Colo., June 1999, which is hereby incorporated by reference. Pixels of the foreground objects are estimated by subtracting the current image frame of the video from the estimated background image. Moving blobs are constructed from the pixels by performing a connected component analysis, which is a well-known image processing technique (see e.g., Fundamentals of Digital Image Processing by Anil Jain, Prentice-Hall, N.J., 1988, which is hereby incorporated by reference).

Each moving blob and its immediate neighborhood or a box containing the moving blob in the current frame of the video can be defined as an RoI and image blocks forming the moving blob are effectively compressed intra-frame using artificially defined motion vectors as described above even in inter-frame encoded frames of the video. Also, image blocks of the RoI are finely quantized in the transform domain compared to non-RoI blocks to increase the quality of representation.

RoI's can be also defined according to humans in the screened area, because the face, height, or posture of a person or an intruder carries important information in surveillance applications. In fact, most of the semantic information in videos is related to human beings and their actions. Therefore, an automatic RoI generation method should determine the boundary of the RoI in an image frame. The aim is to have an RoI containing the human image(s).

Due to its practical importance there are many public domain methods listed in the literature for human face and body detection, see e.g., the public domain document written by G. Yang and T. S. Huang, entitled “Human face detection in a complex background,” published in the scientific journal, Pattern Recognition, 27(1):53-63, in 1994 and the final report of the DARPA (Defense Advanced Research Projects Agency) funded project entitled “Video Surveillance and Monitoring (VSAM),” by R. T. Collins et. al, Carnegie-Mellon University Technical Report with number CMU-RI-TR-00-12, published in 2000, which are both hereby incorporated by reference, in which humans are detected in video from the shape and the boundary information of the moving blobs. In this method, contours describing the boundary of humans at various scales are stored in a database. These contours are extracted from some training videos manually or in a semi-automatic manner. Given a moving blob, its boundary is compared to the contours in the database. If a match occurs then it is decided that the moving blob is a human. Other contours stored in the database of the automatic RoI initiation method include the contours of human groups, cars, and trucks etc.

Object boundary comparison is implemented by computing the mean-square-error (MSE) or the mean-absolute-difference (MAD) between the two functions describing the two contours. There are many ways of describing a closed contour using a one-dimensional mathematical function. For example, a function describing the object boundary can be defined by computing the length of object boundary from the center of mass of the object at various angles covering the 360 degrees in a uniform manner. In addition, color information is also used to reach a robust decision. For example, the color histogram of a car consists of two sharp peaks corresponding to the color of the body of the car and windows, respectively. On the other hand, the histogram of a human being usually has more than two peaks corresponding to the color of pants, the shirt, the hair, and the skin color.

This public domain human detection method is used to detect humans in video. After the detection of a human in a moving blob an RoI covering the moving blob is initiated and the RoI is compressed in an almost lossless manner by using fine quantization levels in the transform domain and intra-frame compression throughout its existence in the video.

Human faces can also be detected by convolving the luminance component of the current image frame of the video with human face shaped elliptic regions. If a match occurs then the mathematical convolution operation produces a local maximum in the convolved image. Smallest elliptic region fits into a 20 pixel by 15 pixel box. Most automatic human detection algorithms and humans can start recognizing people, if the size of a face is about 20 pixel by 15 pixel. After detecting a local maximum after convolution operation the actual image pixels are checked for existence of local minima corresponding to eyes, eyebrows, and nostrils (it is assumed that black is represented by 0 in the luminance image). Since eyes, nostrils and eyebrows are relatively darker than pixels representing the face skin they correspond to local minimums in the face image. In addition, color information within the elliptic region is also verified. For example, a blue or green face is impossible, i.e., if the blue and green values of pixels are significantly larger than the red value of pixels in the elliptic region than this region cannot be the face of a person.

After the detection of a human in the image an RoI covering the region is initiated even if the region does not move. If the region is inside a moving blob then this increases the possibility of existence of a human in the RoI. As described above the RoI is compressed in an almost lossless manner by using fine quantization levels in the transform domain and intra-frame compression throughout its existence in the video.

Manual RoI Initiation: In a surveillance system the RoI's can be manually determined as well. In fact, it is possible to estimate possible regions in which humans or objects of interests can appear. Such regions can be manually selected as RoIs. If such a region is selected by an operator on the screen displaying the video, then this region is compressed in an almost lossless manner by using fine quantization levels in the transform domain and effective intra-frame compression during recording. In FIG. 2, a surveillance camera 230 monitoring a room is shown. RoI 240 can be manually determined according to the height of a typical person to capture human face images as accurately as possible. In this case, the lower end of the RoI is determined by the lower edge of a chin of 1.6 meter tall person and the upper edge of the RoI is determined according to the hair of a 2.1 meter tall person. The vertical edges of the RoI is determined according to the size of the door.

This approach leads to efficient surveillance video coding results because a typical surveillance video may contain sky or moving trees in an open air screening application and it may contain floor or ceiling pixels in an indoor surveillance application. Such non-RoI regions contain no useful semantic information and as little bits as possible should be assigned to such regions. The transform domain coefficients corresponding to such regions should be quantized in a coarse manner so that the number of bits assigned to such regions is less than the finely quantized RoIs. Also, moving clouds or moving trees or moving clock arms can be encoded in an inter-frame manner to achieve high data compression ratios. Possible mistakes due to inter-frame motion prediction will not be important in non-RoI regions.

Although the effective intra-frame compression increases the bit rate in RoI regions, the encoded bit-stream of the present invention, in general, requires less space than a uniformly compressed surveillance video because of spatial and temporal flexibility in non-RoI regions, which can be assigned significantly small number of bits compared to RoIs. In non-RoI portions of surveillance video there is very little motion in general. Therefore, pixels in a non-RoI portion of an image frame at time instant n is highly correlated with the corresponding pixels at image frame at time instant n+1. Such regions can be very effectively compressed by computing the transform of the difference between the corresponding blocks. The present invention, which has a differential encoding scheme at non-RoI portions of the video takes advantage of this fact and drastically reduces the number of bits assigned to such regions containing very little semantic information.

Another important feature of the present invention is its robustness to transmission channel congestion problem from the point of view of useful information representation.

An ordinary video encoder uniformly increases the quantization levels over the entire image to reduce the amount of transmitted bits when there is a buffer overflow or transmission channel congestion problem. On the other hand, this may produce degradation even the loss of very important information in RoIs in surveillance videos. The present invention first increases the quantization levels in non-RoI regions of the video. If the channel congestion gets worse then, it throws away the AC coefficients of the non-RoI blocks and represents them using only their DC coefficients. As a final resort, almost no information about the non-RoI information can be sent. If this bit rate reduction is not enough then the method and the system increases the quantization levels of the RoI blocks as a last choice. In other words, essential information in RoIs of the image is kept as accurate as possible in the case of a buffer overflow or channel congestion.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, it is contemplated that the present innovations can be implemented using any number of different structural implementations. An alternative embodiment of the present invention includes, but is not limited to, a single processor that encodes, decodes, detects the RoI, and combines whatever may need to be combined. This can be implemented using hardware or software.

In another class of contemplated embodiments, the present innovations can be implemented to be compatible with any video coding standard in addition to the MPEG family and JPEG family coding standards.

Further, these innovative concepts are not intended to be limited to the specific examples and implementations disclosed herein, but are intended to included all equivalent implementations, such as, but not limited to, using different types of cameras for capturing the video stream such as a fish-eye, peripheral, global, wide-angle, or narrow-angle camera. This includes, for example, using a PTZ controllable camera to capture the video stream. This also includes, for example, using cameras with or without zoom functions.

In another class of contemplated embodiments, the present innovations can be implemented using, in addition to motion detection and object tracking, 3d-perspective view comparisons to identify the RoI. For example, if the video stream captured a row of windows, the image processing circuitry could be programmed to ignore unimportant movement, such as leaves falling, and only identify as RoI open windows.

In another class of contemplated embodiments, the video compression can be lossless both inside and outside the RoI. In an alternative embodiment, the video compression can be lossy both inside and outside the RoI.

Other classes of contemplated embodiments include a camera being fixed on a certain region, for example an entrance, and having the RoI be specified as a human face of an entrant. In addition, the camera could be a PTZ controllable camera that could then follow the face region as it travels throughout the scene. In an alternative embodiment, the camera can be a fish-eye camera that produces wide-angle images and software can be used to follow the face region as it travels around the room.

Additional general background, which helps to show variations and implementations as well as the level of ordinary skill in the art, may be found in the following items, all of which are hereby incorporated by reference: U.S. Pat. No. 6,757,434 entitled “Region-of-Interest Tracking Method and Device for Wavelet-Based Video Coding;” U.S. Pat. No. 6,763,068 entitled “Method and Apparatus for Selecting Macroblock Quantization Parameters in a Video Encoder;” U.S. application 20030128756 entitled “Method and Apparatus for Selecting Macroblock Quantization Parameters in a Video Encoder;” U.S. application Ser. No. 10/837,825 (Attorney Docket No. GRND-14), filed Apr. 30, 2004, entitled “Multiple View Processing in Wide-Angle Video Camera;” LeGall, D., “MPEG:A Video Compression Standard for Mulitmedia Applications,” Communications of the ACM: 34 (4), April 1991. pp. 47-58; T. Sikora, “The MPEG-4 video standard verification model,” IEEE Trans. Circuits Syst. Video Technol., vol. 5, pp. 19-31, February 1997; ISO/IEC International Standard part-2 14496-2, 2001; ISO/IEC International Standard part-10 14496-10, 2001; W. Pennebaker and J. Mitchell, JPEG: still image data compression standard, Van Nostrand Reinhold, NY, 1992; Majid Rabbani, Rajan Joshi, “An overview of the JPEG2000 still image compression standard,” Signal Processing: Image Communication, pp. 3-48, vol. 17, 2002; JPEG 2000 Image Coding System, ISO/IEC International Standard, 15444-1, 2000; Charilaos Christopoulos (editor), ISO/IEC JTC1/SC29/WG1 N988 JPEG 2000 Verification Model Version 2.0/2.1, Oct. 5, 1998; all of which are hereby incorporated by reference.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

1. A method of intelligently compressing video by applying varying compression methodology to selected regions of interest, comprising the steps of
a. identifying one or more regions of interest in a frame of a video sequence,
b. compressing said one or more regions of interest of said frame using only intra-frame information,
c. compressing exterior of said one or more regions of interest using a plurality of frames of said video sequence, and
d. repeating steps a) to c) and combining compressed data from said exterior of regions of interest with said regions of interest to create a bit-stream representing the plurality of frames of said video sequence.

2. The method of claim 1 in which the said detection algorithm are human posture detection algorithm.

3. The method of claim 1 in which the said detection algorithm are human face detection algorithm.

4. The method of claim 1 in which the linear transformation technique is the Discrete Cosine Transform.

5. The method of claim 1 in which the linear transformation technique is a wavelet transform.

6. The method of claim 1 in which the transform operation is carried out over a plurality of image pixel blocks whose union covers the entire image frame.

7. The method of claim 1 in which the quantized transform domain coefficients are encoded in binary form using Huffman coding.

8. The method of claim 1 in which the quantized transform domain coefficients are encoded in binary form using arithmetic coding.

9. The method of claim 1 wherein said regions of interest are compressed using intra-frame information by canceling the motion estimation and the camera motion compensation process in differentially compressed video data.

10. The method of claim 1 in which differential video data compression methods include MPEG-1 video compression standard.

11. The method of claim 9 in which differential video data compression methods include MPEG-1 video compression standard.

12. The method of claim 1 in which differential video data compression methods include MPEG-2 video compression standard.

13. The method of claim 9 in which differential video data compression methods include MPEG-2 video compression standard.

14. The method of claim 1 in which differential video data compression methods include MPEG-4 video compression standard.

15. The method of claim 9 in which differential video data compression methods include MPEG-4 video compression standard.

16. The method of claim 1 in which motion estimation and camera motion compensation are effectively cancelled by artificially defining all of the motion vectors within the said regions of interest with respect to a DC only encoded block outside the regions of interest.

17. The method of claim 9 in which motion estimation and camera motion compensation can be effectively cancelled by artificially defining all of the motion vectors within the said regions of interest with respect to a DC only encoded block outside the regions of interest.

18. The method of claim 10 in which motion estimation and camera motion compensation can be effectively cancelled by artificially defining all of the motion vectors within the said regions of interest with respect to a DC only encoded block outside the regions of interest.

19. The method of claim 11 in which motion estimation and camera motion compensation can be effectively cancelled by artificially defining all of the motion vectors within the said regions of interest with respect to a DC only encoded block outside the regions of interest.

20. The method of claim 12 in which motion estimation and camera motion compensation can be effectively cancelled by artificially defining all of the motion vectors within the said regions of interest with respect to a DC only encoded block outside the regions of interest.

21. The method of claim 13 in which motion estimation and camera motion compensation can be effectively cancelled by artificially defining all of the motion vectors within the said regions of interest with respect to a DC only encoded block outside the regions of interest.

22. The method of claim 1 in which said regions of interests in the video can be also determined manually by a user.

23. The method of claim 1 in which exterior of RoIs can be compressed using any image and video coding method.

24. The method of claim 1 in which no side information describing said Regions of Interest is transmitted to the encoder.

25. A computer readable medium containing programming instructions for intelligently encoding a video sequence by applying varying compression methodology to selected regions of interest comprising
a detection algorithm for automatically identifying one or more regions of interest within a video sequence,
encoding said video sequence, while automatically using different encoding parameters for said regions of interest

26. The computer-readable medium of claim 25 in which the detection algorithm can be human posture detection algorithm.

27. The computer-readable medium of claim 25 in which the detection algorithm can be human face detection algorithm.

28. The computer-readable medium of claim 25, wherein the linear transform can be the Discrete Cosine Transform.

29. The computer-readable medium of claim 25, wherein the linear transform can be a wavelet transform.

30. The computer-readable medium of claim 25, wherein the transform operation can be carried out over plurality of image pixel blocks whose union covers the entire image frame.

31. The computer-readable medium of claim 25, wherein the quantized transform domain coefficients can be encoded in binary form using Huffman coding.

32. The computer-readable medium of claim 25, wherein the quantized transform domain coefficients can be encoded in binary form using arithmetic coding.

33. The computer-readable medium of claim 25, in which said regions of interest are compressed by using intra-frame information by canceling the motion estimation and the camera motion compensation process in differentially compressed video data.

34. The computer-readable medium of claim 25 in which differential video data compression methods include MPEG-1 video compression standard.

35. The computer-readable medium of claim 33 in which differential video data compression methods include MPEG-1 video compression standard.

36. The computer-readable medium of claim 25 in which differential video data compression methods include MPEG-2 video compression standard.

37. The computer-readable medium of claim 33 in which differential video data compression methods include MPEG-2 video compression standard.

38. The computer-readable medium of claim 25 in which differential video data compression methods include MPEG-4 video compression standard.

39. The computer-readable medium of claim 33 in which differential video data compression methods include MPEG-4 video compression standard.

40. The computer-readable medium of claim 25 in which motion estimation and camera motion compensation can be effectively cancelled by artificially defining all of the motion vectors within the said regions of interest with respect to a DC only encoded block outside the regions of interest.

41. The computer-readable medium of claim 34 in which motion estimation and camera motion compensation can be effectively cancelled by artificially defining all of the motion vectors within the said regions of interest with respect to a DC only encoded block outside the regions of interest.

42. The computer-readable medium of claim 35 in which motion estimation and camera motion compensation can be effectively cancelled by artificially defining all of the motion vectors within the said regions of interest with respect to a DC only encoded block outside the regions of interest.

43. The computer-readable medium of claim 36 in which motion estimation and camera motion compensation can be effectively cancelled by artificially defining all of the motion vectors within the said regions of interest with respect to a DC only encoded block outside the regions of interest.

44. The computer-readable medium of claim 37 in which motion estimation and camera motion compensation can be effectively cancelled by artificially defining all of the motion vectors within the said regions of interest with respect to a DC only encoded block outside the regions of interest.

45. The computer-readable medium of claim 25 in which said regions of interests in the video can be also determined manually by a user.

46. The computer-readable medium of claim 25 in which exterior of RoIs can be compressed using any image and video coding method.

47. The computer-readable medium of claim 25 in which no side information describing said Regions of Interest is transmitted to the encoder.

48. A system for processing video streams comprising:
an encoder which automatically uses a first level of resolution coding on identified regions of interest, and a lower level of resolution on other regions within the scene;
an operation which transmits an output stream from said encoder, representing both said regions of interest and said other regions, said output stream being compatible with one or more standard types of decoder; and
a data channel connected to receive said output stream.

49. A system for processing video streams comprising:
an operation which identifies regions of interest within a scene;
an encoder which automatically uses a first level of resolution coding on said regions of interest, and a lower level of resolution on other regions within the scene;
an operation which transmits the combined output stream from said encoder, representing both said regions of interest and said other regions, said output stream being compatible with one or more standard types of decoder; and
a data channel connected to receive said output stream.

50. The system of claim 49 in which no additional information identifying said regions of interest is transmitted with said output stream.

51. A method of intelligently encoding video comprising the actions of:
encoding said video sequence, while automatically using different encoding parameters for said regions of interest.

52. The method of claim 51, in which at least one of said regions of interest is a predefined location.

53. The method of claim 51, in which at least one of said regions of interest is defined by an algorithm detecting changes in the scene.

54. A system for communicating video streams comprising:
an operation which identifies regions of interest in a scene;
an encoder which encodes said regions of interest and other regions in the scene using different encoding parameters,
which automatically encodes said regions of interest using compression technology based on intra-frame data,
which encodes said other regions using compression technology based at least in part on inter-frame data,
and which produces an output stream which is compatible with one or more standard types of decoders; and
a data channel connected to receive said output stream.

55. A method comprising the actions of:
identifying regions of interest in a scene;
encoding a video stream;
wherein said encoding automatically compresses said regions of interest less than other regions in said scene during the encoding process, and
wherein said encoding of said other regions uses an inter-frame comparison process.

56. The method of claim 55, in which the encoding of said other regions is more lossy than the encoding of said regions of interest.

57. The method of claim 55, in which the encoding of said regions of interest involves automatically decreasing the size of the quantization levels during the encoding process.

58. A method comprising the actions of:
identifying regions of interest within a scene, wherein said regions of interest are specified as those regions in which a human face is most likely to reside;
encoding both said regions of interest and other regions within the scene, while automatically using different encoding parameters for said regions of interest, to produce an encoded representation of said regions of interest and said other regions; and
transmitting said encoded representation, to thereby represent said regions of interest and said other regions together.

59. The method of claim 1 wherein said identification of regions of interest involves automatic motion analysis, which includes motion detection, and/or moving region tracking and/or object tracking.

60. The method of claim 1 wherein said identification of regions of interest is sensitive to the position of objects with well defined features such as those of humans and vehicles in said frame.

61. The method of claim 1 wherein said compression operations are based on a MPEG video compression standard, such as MPEG-1, MPEG-2 or MPEG-4.

62. The method of claim 1 wherein said compression of exterior of regions of interest is based on key intra-frames in close sequential (temporal) proximity to the current frame.

63. The method of claim 61 wherein said regions of interest are compressed using intra-frame information by canceling the motion estimation and the camera motion compensation process in differentially compressed video data.

64. The method of claim 51 wherein said automatic identification of regions of interest involves automatic motion analysis, which includes motion detection, and/or moving region tracking and/or object tracking.

65. The method of claim 51 wherein said identification of regions of interest is sensitive to the position of objects with well defined features such as those of humans and vehicles in said frame.

66. The method of claim 51 wherein said compression is based on a linear transformation technique including the Discrete Cosine Transform or Wavelet Transform wherein the computed transform domain coefficients are quantised and encoded in binary form using a known coding scheme, including Huffman or arithmetic coding.

67. The method of claim 51 wherein said encoding operation is carried out over a plurality of image pixel blocks whose union covers the entire image frame.

68. The method of claim 51 wherein said encoding operation is based on a MPEG video compression standard, such as MPEG-1, MPEG-2 or MPEG-4.

69. A method of intelligently processing video comprising the steps of:
a) identifying one or more regions of interest in a frame of a video sequence;
b) compressing interior of said one or more regions of interest of said frame at a first compression ratio.
c) compressing exterior of said one or more regions of interest of said frame at a second higher compression ratio; and
d) repeating steps a) to c) and combining compressed data from said interior and exterior of regions of interest to create a bit-stream representing the plurality of frames of said video sequence.

70. The method of claim 69 wherein said identification of regions of interest involves automatic motion analysis, which includes motion detection, and/or moving region tracking and/or object tracking.

71. The method of claim 69 wherein said identification of regions of interest is sensitive to the position of objects with well defined features such as those of humans and vehicles in said frame.

72. The method of claim 69 wherein said compression is based on a linear transformation technique including the Discrete Cosine Transform or Wavelet Transform wherein the computed transform domain coefficients are quantised and encoded in binary form using a known coding scheme, including Huffman or arithmetic coding.

73. The method of claim 69 wherein said compression operations are carried out over a plurality of image pixel blocks whose union covers the entire image frame.

74. The method of claim 69 wherein said compression operations are based on a MPEG video compression standard, such as MPEG-1, MPEG-2 or MPEG-4.

75. The method of claim 69 wherein said one or more regions of interest in said video frames are static and can be determined manually by an operator.

76. The method of claim 69 wherein the steps of identification of regions of interest and encoding are performed in separate computer systems.

77. The method of claim 69 wherein side information describing said regions of interest is included with the bit-stream.
